(19) United States
(12) Patent Application Publication
(10) Pub. No.: US 2012/0171545 A1
(43) Pub. Date: Jul. 5, 2012

(54) ELECTRICAL ENERGY STORAGE DEVICE HAVING FLAT CELLS AND HEAT SINKS

(75) Inventors: Claus-Rupert Hohenthanner, Hanau (DE); Torsten Schmidt, Landsberg (DE); Andreas Gutsch, Luedinghausen (DE); Jens Meintschel, Bernsdorf (DE)

(73) Assignee: LI-TEC BATTERY GMBH, Kamenz (DE)

(21) Appl. No.: 13/263,157

(22) PCT Filed: Mar. 1, 2010
(86) PCT No.: PCT/EP10/01261

§ 371 Date: Mar. 21, 2012

(30) Foreign Application Priority Data
Apr. 8, 2009 (DE) 10 2009 016 866.4

(51) Int. Cl. H01M 10/50

(52) U.S. Cl. 429/120

(57) ABSTRACT

The invention relates to an electrical energy storage device comprising: a plurality of flat storage cells for storing and discharging electrical energy, having opposing, flat current conductors, a plurality of spacer elements for maintaining a predetermined distance between the storage cells, and a clamping means for clamping the cells into a stack, wherein cells are clamped by the clamping means at the current conductors thereof between spacer elements by means of a force fit, wherein at least some of the spacer elements are designed as heat sinks. The heat sinks have fins extending sideways out from the stack. The heat sinks are alternatively thermally connected to the current conductors by means of a soft, heat conductive material. In a further alternative, two heat sinks are disposed between adjacent current conductors. In a final alternative, the spacer elements comprise relief holes for weight reduction. The alternatives can be combined.

Priority application DE 10 2009 016 866.4 is fully incorporated by reference into the present application.

The present invention relates to an electric energy storage device comprising flat cells and heat sinks.

It is known to design electric energy storage cells in the form of flat and rectangular storage elements. Such electric energy storage cells are, for example, what are referred to as pouch or coffee bag cells, in the form of flat and rectangular storage cells for electric energy (battery cells, rechargeable battery cells, capacitors, . . . ), the electrochemically active part of which is surrounded by a film-like packaging through which electric connections (poles) in sheet metal form, referred to as (current) conductors) are guided. It is further known to compose an electric energy storage device from a plurality of such electric energy storage cells, which are combined by means of a clamping unit to form a block. The electric series or parallel connection of the cells is created by conductive contact elements, which establish the electric connection between the corresponding current conductors of adjacent cells. It is common to dispose the cells, which are either received loosely in a frame or pressed together by way of a clamp or the like, in a stack (also referred to as “cell block) and connect the poles exposed at the top on a narrow side of the cells using suitable means.

Heat that develops in the electrochemically active part of the cells is typically dissipated by way of forced or natural convection. However, if the power dissipation is high, the heat that develops may be too high and difficult to control.

It is an object of the present invention to improve the heat dissipation of an electric energy storage cell in an electric energy storage device that is composed of electric energy storage cells. It is a further object of the present invention to create an electric energy storage device having the least possible number of required components. Another object of the present invention is to lower the weight of a cell array or of an electric energy storage device. A further object consists in providing an electric energy storage device, in which a number of flat storage cells are arranged in a space-saving and easy-to-install manner in a stable block, are securely fixed and reliably interconnected, and effectively and reliably remove the waste heat of the cells and the conductors, while keeping the weight of the array low.

The object is achieved by the characteristics of the independent claims. Advantageous refinements of the invention form the subject matter of the dependent claims.

According to a first aspect of the present invention, an electric energy storage device comprises: a plurality of flat storage cells for storing and delivering electric energy, having opposing, flat current conductors, a plurality of spacer elements for maintaining a predetermined distance between the storage cells, and a clamping means for clamping the cells to form a stack, wherein cells are clamped by the clamping means at the respective current conductors between spacer elements by means of a non-positive connection, wherein at least some of the spacer elements are designed as heat sinks, and wherein the heat sinks comprise fins that protrude laterally out of the stack.

Because the current conductors of the cells are clamped by the clamping means between respective spacer elements by means a non-positive connection, a predetermined distance is maintained between adjacent cells, which can be adjusted so that no clamping force is exerted on an electrochemically active part of the cells. This has advantages with respect to the functional reliability and durability of the cells; moreover, the flat sides of the cells can thus emit heat to a heat transfer medium, or optionally take up heat from the same, for example during a start a low temperatures. In addition, heat can be exchanged with the surroundings by way of the heat sinks via the conductors. This function is effectively supported by the outwardly directed fins, which also enable deliberate guidance or turbulence of the cooling medium.

According to a second aspect, an electric energy storage device comprises: a plurality of flat storage cells for storing and delivering electric energy, having opposing, flat current conductors, a plurality of spacer elements for maintaining a predetermined distance between the storage cells, and a clamping means for clamping the cells to form a stack, wherein cells are clamped by the clamping means at the respective current conductors between spacer elements by means of a non-positive connection, wherein at least some of the spacer elements are designed as heat sinks, and wherein the heat sinks are thermally connected to the current conductors by means of a soft, heat conducting material. According to this aspect, the heat sinks preferably comprise fins.

The effects essentially correspond to the first aspect. In addition, the heat transfer between the current conductors and heat sinks can be improved by the soft, heat conducting material, notably if a gap is present in between due to the non-positive or positive arrangement.

According to a third aspect, an electric energy storage device comprises: a plurality of flat storage cells for storing and delivering electric energy, having opposing, flat current conductors, a plurality of spacer elements for maintaining a predetermined distance between the storage cells, and a clamping means for clamping the cells to form a stack, wherein cells are clamped by the clamping means at the respective current conductors between spacer elements by means of a non-positive connection, wherein at least some of the spacer elements are designed as heat sinks, and wherein two heat sinks are disposed between adjacent current conductors. According to this aspect, the heat sinks preferably comprise fins.

The effects essentially correspond to the first aspect. In addition, dividing the heat sinks disposed between the conductors into two parts facilitates installation. This feature means that heat sinks are disposed in particular symmetrically on the upper faces and lower faces of the conductors. It is therefore possible to preassemble storage cells with the symmetrically disposed heat sinks, for example by gluing them together using a heat conducting adhesive or the like.

In these aspects, the fins on the heat sink are preferably offset non-symmetrically away from the current conductor, preferably in the stacking direction. In this way, the location of the heat transmission to the surroundings or a cooling medium is removed from the location of the heat transfer with the current conductor. If additionally an intermediate piece is disposed between the two heat sinks, sufficient spacing can be maintained between the fins of the two heat sinks and, in addition, it is possible, when using an insulating intermediate piece, to suppress undesirable contacting of adjacent current conductors via the heat sinks, or establish such contacts via a conductive intermediate piece.

According to a fourth aspect, an electric energy storage device comprises: a plurality of flat storage cells for storing and delivering electric energy, having opposing, flat current conductors, a plurality of spacer elements for maintaining a predetermined distance between the storage cells, and a clamping means for clamping the cells to form a stack, wherein cells are clamped by the clamping means at the respective current conductors between spacer elements by means of a non-positive connection, wherein at least some of the spacer elements are designed as heat sinks, and wherein the spacer elements comprise relief bores for weight reduction. According to this aspect, the heat sinks preferably comprise fins.

The effects essentially correspond to the first aspect. In addition, the relief bores allow the total weight of the electric energy storage device to be reduced.

Further weight reduction is possible for all aspects if the heat sinks comprise not only pressure surfaces, which exert pressure on the current conductors by means of the clamping means, but also one or more free spaces, which are recessed in the stacking direction in relation to the pressure surfaces. Such free spaces form additional heat transfer surfaces. They can also enable fluid communication between an interior of the stack and the surroundings, whereby heat transport is improved. If, in addition, the relief bores of the fourth aspect are arranged in the free spaces, the relief bores form additional heat transfer surfaces.

The spacer elements can optionally be equipped for electric through-plating or for electric insulation in the stacking direction. The functions of the stack structure, which is to say clamping and mounting of the storage cells, maintaining the distance, cooling and interconnection, can thus be implemented by and the same components.

The heat sinks can be produced in particular from a conductive material, for example a conductive ceramic material, a conductive composite material, a metallic conductor material, or the like.

The invention can be applied particularly advantageously to rechargeable lithium ion batteries.

The above and further characteristics, objects and advantages of the present invention will become more apparent from the following description, which was prepared with reference to the enclosed drawings.

In the drawings:

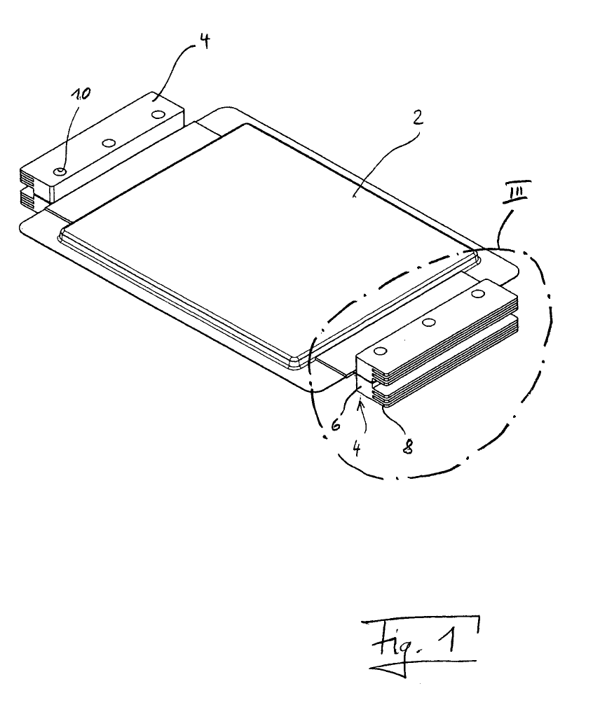

FIG. 1 is a perspective illustration of a cell array, comprising an electric energy storage cell and two heat sinks, as a first exemplary embodiment of the present invention;

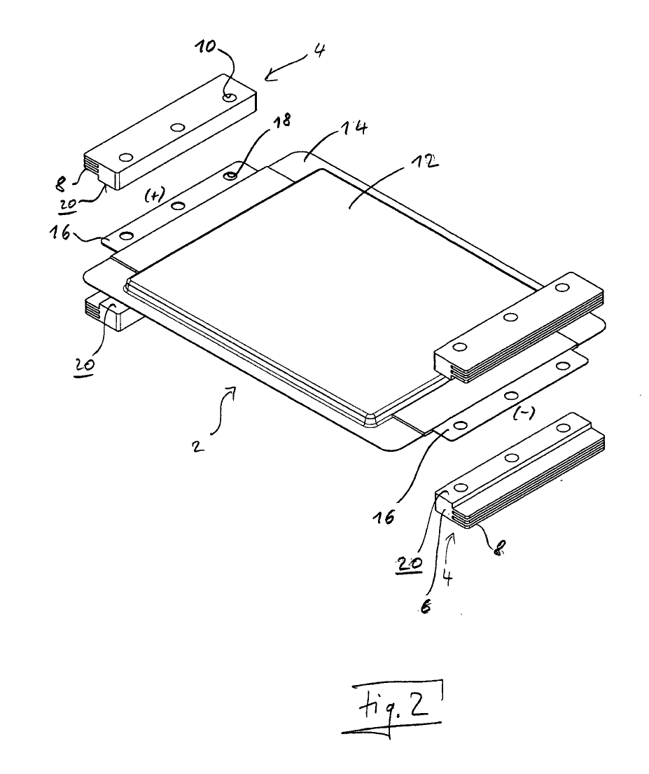

FIG. 2 is a perspective exploded view of the cell array of FIG. 1;

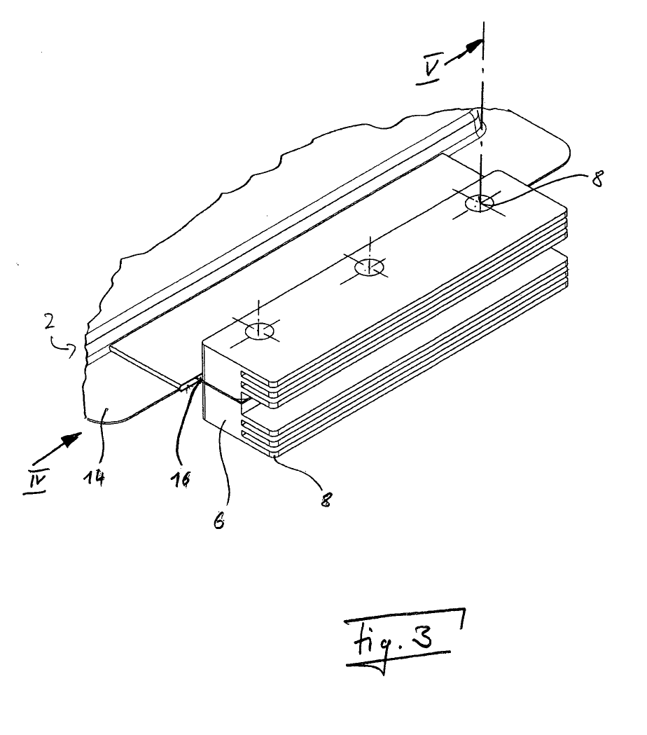

FIG. 3 an enlarged view of a detail “III” of FIG. 1;

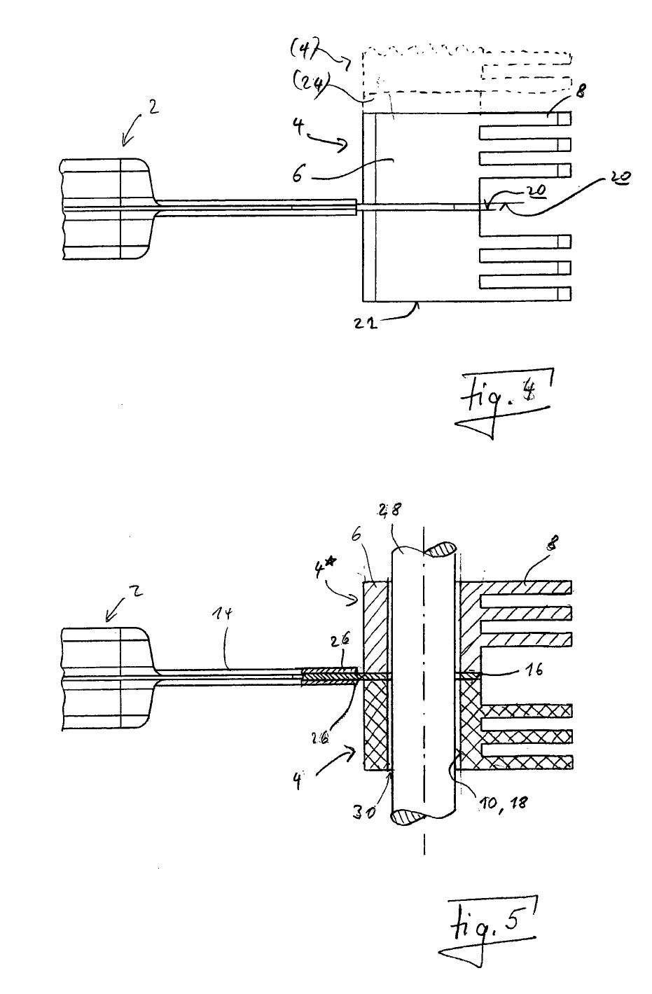

FIG. 4 is a further enlarged view of detail “III” in the direction of an arrow “IV” of FIG. 3;

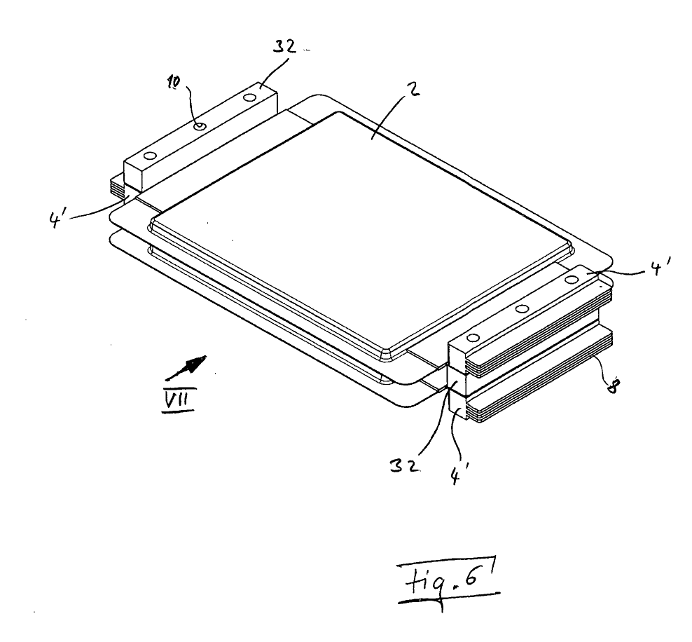

FIG. 5 is a view of more details of the array of FIG. 4 in a partial sectional view on a line “V” in FIG. 3;

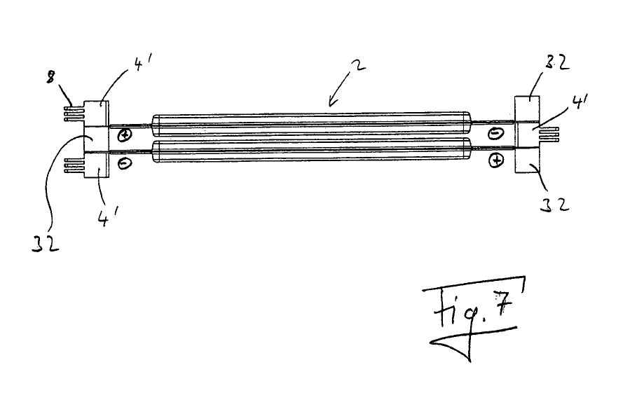

FIG. 6 is a perspective illustration of a cell array, comprising two electric energy storage cells as well as heat sinks and insulating bodies, as a second exemplary embodiment of the present invention;

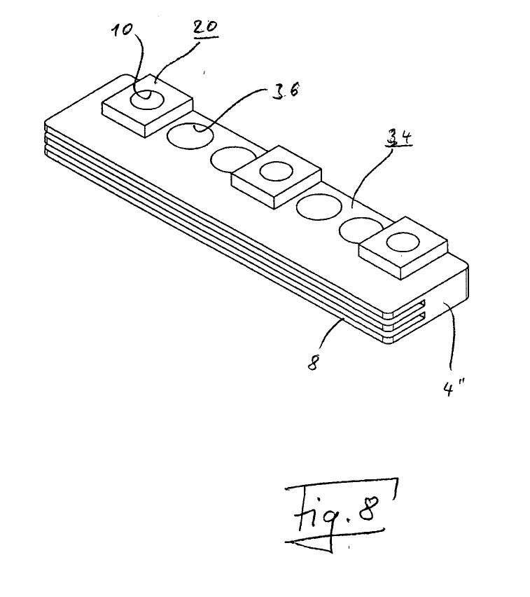

FIG. 7 is a view of the cell array in FIG. 6 in the direction of an arrow “VII”; and

FIG. 8 shows a perspective illustration of a heat sink of a third exemplary embodiment of the present invention.

It should be pointed out that the illustrations in the figures are schematic and limited to reproducing only characteristics that are key for understanding the invention. It should also be pointed out that the dimensions and proportions shown in the figures are merely intended to clarifying the illustration and shall not be construed in a limiting manner whatsoever.

A first exemplary embodiment of the present invention will now be described based on FIGS. 1 to 5. To this end, FIG. 1 is a perspective illustration of a cell array, comprising an electric energy storage cell and two heat sinks, as a first exemplary embodiment of the present invention; FIG. 2 is a perspective exploded view of the cell array of FIG. 1; FIG. 3 is an enlarged illustration of a detail “III” of FIG. 1; FIG. 4 is a further enlarged illustration of detail “III” in the direction of arrow “IV” of FIG. 3; and FIG. 5 is a view of more details of the array of FIG. 4 in a partial sectional view on a line “V” in FIG. 3.

FIG. 1 shows a perspective view of an array comprising an electric energy storage cell 2 and four heat sinks 4.

According to the illustration of FIG. 1, the heat sinks 4 are arranged in pairs of both lateral sides of the electric energy storage cell. Each of the heat sinks 4 comprises a solid part 6 and three fins 8, which project away from the solid part 6 of the storage cell 2, which is to say outwardly.

FIG. 2 shows an exploded view of the array in FIG. 1 for clarification.

According to the illustration of FIG. 2, the storage cells 2 are designed as flat cells or pouch cells having opposing, flat current conductors. More precisely, each storage cell 2 comprises an active part 12, a sealing seam (an edge region) 13 and two current conductors 14. The electrochemical reactions for storing and delivering electric energy take place in the active part 10. In principle, any type of electrochemical reaction can be used for developing storage cells; the description, however, relates in particular to rechargeable lithium ion batteries, to which the invention can be applied particularly well given the requirements in terms of mechanical stability and thermal economy as well as the economic significance. The active part 12 is enclosed by two films in a sandwich-like manner, wherein the protruding edges of the films are welded together in a gas-tight and fluid-tight manner and form the sealing seam 14. A positive or a negative current conductor (cell pole) 14 projects from two opposing narrow sides of the storage cell 2.

The solid part 6 of the heat sink 4 comprises a pressure surface 20. The pressure surfaces 20 of two heat sinks 4 oppose each other and together surround one of the current conductors 16 of the storage cell 2. This fact is more clearly apparent from FIG. 3, which shows an enlarged view of a conductor region “III” in FIG. 1, and from FIG. 4, which shows an even further enlarged illustration of this region from a different perspective, this being in the direction of arrow “IV” in FIG. 3.

Back in FIG. 2, three bores 18 (hereafter referred to as “pole bores” 18) are provided in the conductors 16. The pole bores 18 are aligned with the through-holes 10 in the solid parts 6 of the heat sinks 4. Pins or tension rods (not shown in detail) extend through the bores 10, 18 and are used to clamp the conductors 18 of the cell 2 firmly between the pressure surfaces 20 of the heat sinks 4. Corresponding counter-bearings of the clamping connection, such as parts of a housing or the like, are also not shown in detail in the figure.

The heat sinks 4 effect improved cooling via the fins 8. Cooling can be further improved by a flow of cooling fluid such as air, water or oil along the fins 8; to this end, the fins on the heat sink or parts thereof can be used to guide the cooling fluid or cause deliberate turbulence of the same. The solid parts 6 of the heat sinks 8 are in contact with the conductors 16 of the storage cell 2. Thus, good heat transfer takes place, and the heat emission from the interior of the cell 2 to the heat sinks 4 is highly effective.

The heat sinks 4 are also used to clamp the conductors 16 in place, thus retaining the storage cells 2 in place. They are further used as spacers, which is to say they ensure a predetermined distance between the cell 2 and a housing or the like. This prevents mechanical action on the active part 12 of the cell 2 and effective avoids resulting impairment of the electrochemical process in the interior of the cell. In addition, it allows a cooling medium to flow around the entire cell 2, whereby additional cooling is assured.

Several of the arrays according to FIGS. 1 to 4 can be linked or stacked. In this way, a heat sink 4 is followed by another heat sink 4, another cell 2, and another heat sink 4, and so forth. FIG. 4 indicates such a continuation with dotted lines. It should be noted that the fins 8 are disposed unilaterally toward the side facing away from the conductor 16. In the example shown, a first fin 8 is offset from the pressure surface 20, while the last fin 8 is aligned with the surface 22 opposite of the pressure surface 20. In order to prevent two fins 8 from being seated directly on top of each other with multiple stacked cell arrays, an intermediate body 24 is disposed between consecutive surfaces 22.

A series connection of multiple storage cells 2, which in practical experience is particularly significant, can be particularly easily implemented by alternating pole positions of the conductors 16 and the reciprocal connection thereof. However, parallel circuits, or combinations of parallel and series connections, of multiple cells 2 can be implemented by a suitable arrangement.

The heat sinks 4 are made of an easily heat conducting material, such as a metal, a ceramic material, a composite material, or the like. The material of the heat sinks 4 can be defined in more detail in several alternatives in terms of the conductive properties.

The heat sinks 4 can also be used as electric contact elements, or as insulating bodies, as will be described below based on specific alternatives, and thus be used in a simple manner for electrically interconnecting multiple cells among each other and for producing the electric contact with a load or a power source.

In a first specific alternative, the heat sinks 4 are produced from an easily electrically conducting material. A direct electric connection to the corresponding current conductor 16 of the cell 2 can thus be established via the heat sink 4.

In a second specific alternative, the heat sinks 4 are produced from an electrically insulating material. An electric connection is established in this case in a different manner, for example by way of clamped-in wires or foils or the like; however, reliable electric insulation of the voltage-carrying current conductors 16.

The two alternatives can be combined with each other. FIG. 5 shows the array of FIG. 4, wherein the laterally outer regions of the conductor 16 and of two heat sinks are cut in a plane extending through the through-hole 10 in the solid parts 6 of the heat sinks 4 (see arrow “V” in FIG. 3). More specifically, an array is shown in which two heat sinks 4, 4* made of different materials are used. The lower heat sink 4 in the drawing is made of an electrically insulating material, while the upper heat sink 4* is made of an electrically conductive material. In other words, one side (the lower one in the drawing) of the conductor 16 is electrically separated from the insulating heat sink 4 of components located further below, while the other side (the upper one in the drawing) of the conductor 16 can be electrically connected to components located up higher by way of the conducting heat sink 4.

If the reverse arrangement of the heat sinks 4, 4* is selected on the left side of the cell 2, which is not visible in the drawing, which is to say is selected so that the insulating heat sink 4 is located at the top and the conducting heat sink 4* at the bottom, the potential of the positive pole can be tapped on the one flat side of the cell 2 and the potential of the negative pole can be tapped on the other flat side of the cell 2, for example via electrically conductive housing halves. In this way, a series connection of multiple cells 2 can also be easily implemented by arranging either two insulating heat sinks 4 or two conducting heat sinks 4* alternately between the conductors 16 of adjacent cells 2. The intermediate bodies 24 (or 24*) are then, of course, designed accordingly insulating or conducting.

FIG. 5 also specifically shows that the conductor 16 protrudes in the edge region 14 between the two enveloping films 26, which form the sealing seam, from the interior of the cell 2, where it is connected to the active part of the cell 2.

FIG. 5 further shows a pin 28, which extends through the aligned through-holes 10 of the two heat sinks 4 shown and the pole bore 18 of the cell 2. It should be noted that such a pin 18 is provided for each of the total of six pole bores 18 with the respectively associated through-holes 10. The pin 18 serves as a tension rod or as a clamping element, by mean of which the conductors 18 of the cell 2 are rigidly clamped between the pressure surfaces 20 of the heat sinks 4. Corresponding counter-bearings of the clamping connection, such as parts of a housing or the like, are also not shown in detail in the figure, but are automatically apparent.

It should further be noted that the outside diameter of the pin 18 is smaller than the diameters of the through-holes 10 and of the pole bore 18, whereby an annular air gap 30 is obtained. As an alternative or in addition, the pin 18 may be surrounded by an insulating coating or an insulating sleeve.

In a third specific alternative, the heat sinks 4 are produced from an electrically poorly conducting material. In this case, an electric connection is established in a different manner. However, reliable electric insulation of the current conductors 16 must be assured by additional measures; for example, insulating intermediate bodies 24 can be used. In this case, the electrical conductivity of the heat sinks 4 does not matter; rather, the heat conducting properties can be optimized, without consideration of the electric properties.

FIGS. 6 and 7 show an array of two electric energy storage cells 2 and a plurality of heat sinks 4 and spacer 32 as a second exemplary embodiment of the present invention. To this end, FIG. 6 shows a perspective overall view and FIG. 7 shows an edge-side top view of the array in the direction of arrow “VII” of FIG. 6. The design of the storage cells 2 is identical to the design described in connection with the first exemplary embodiment.

According to the illustrations of FIGS. 6 and 7, two storage cells 2 are arranged in a stacked array. The array is selected for a series connection so that the positive pole (conductor) of one cell 2 is located opposite of the negative pole of the other cell. The current conductors on the one lateral side of the cells 2 (right side in FIG. 7) are spaced apart from each other by a heat sink 4′, and the current conductors on the other lateral side of the cells 2 (left side in FIG. 7) are spaced apart from each other by a spacer 32. In the stacking direction, a heat sink 4′ is followed in each case by a spacer 32 and conversely.

The heat sinks 4′ in this exemplary embodiment are produced from electrically conductive material, while the spacers 32 are produced from an electrically insulating material. A series connection is thus implemented even in a longer string of a plurality of storage cells 2 according the aforedescribed pattern.

In this exemplary embodiment, only one heat sink 4′ or one spacer 32 is disposed between the respective current conductors of adjacent storage cells 2. Intermediate pieces 24, as in the first exemplary embodiment, can be dispensed with. As a result, in an array having a predefined number of storage cells 2, the number of parts is reduced as compared to the first exemplary embodiment, and assembly is accordingly simplified. Contrary to the first exemplary embodiment, the fins 8 are configured symmetrically on the heat sinks 4′ in relation to the stacking direction.

In one modification of this exemplary embodiment, the heat sinks 4′ are produced from an electrically insulating material, while the spacers 32 are produced from an electrically conductive material.

In a further modification of the exemplary embodiment, or the modification, the heat sinks 4′ are produced from a material that has been optimized with respect to heat conduction, without consideration of the electrical conductivity. The electric connection or the electric insulation by a heat sink 4′ is then optionally implemented by other measures.

In a last modification of this exemplary embodiment, the spacers 32 are also provided with fins and therefore are also used as heat sinks.

FIG. 8 shows a perspective illustration of a heat sink 4″ as a third exemplary embodiment of the present invention.

The heat sink 4″ of this exemplary embodiment differs from the heat sink 4′ of the second exemplary embodiment in two regards. First, the thickness of the heat sink 4″ has been reduced in all regions, except for the direct surroundings of the through-holes 10. This means that the pressure surfaces 20 are limited to the immediate region around the through-holes 10, where also the pins pass through. A free space 34 is configured in the remaining region, which has no pressure applied by the clamping connection. The free space 34 is provided with blank holes or relief bores 36, which extend parallel to the through-holes 10. The relief bores 34 can be designed continuous or as blind holes, either on one side or on both sides.

The free spaces 34 as well as the relief bores 36 cause a significant weight reduction of the heat sink 4″ and increase the heat transfer surface to the cooling medium. The free spaces 34 also enable an exchange of the cooling medium between a region between storage cells (not shown in detail) disposed in a stack or in an electric energy storage device and surroundings of the stack, and thus further improved heat transport.

While the present invention was described above with reference to specific exemplary embodiments in terms of the key characteristics, it shall be understood that the invention is not limited to these exemplary embodiments, but can be modified and expanded in the scope and range predefined by the claims.

All the heat sinks and spacers shown and described in the exemplary embodiments can be used alone for clamping and composing a cell block, or they can be received in frame-like components (not shown in detail) inside corresponding recesses. Such frame elements then form a block that is geometrically final toward the outside and contribute to the stabilization of the structure. Such frames can also comprise a recess for receiving a heat sink only on one side, while the other side of the frame as such serves as a space, analogously to the array in the second exemplary embodiment.

All exemplary embodiments can be modified in that electric connection takes place between or with conductors 16 via special contact elements, which are introduced in the heat sinks. These can be sleeves, for example, which additionally surround the pins 28.

The heat transfer between the conductor and heat sink can be improved by thermally conductive potting compounds, adhesives, pates or elastic thermally conductive films. In this way, the gaps between the conductor and heat sink, which develop with a non-positive or positive connection, can be bridged.

The number of fins 6 in the exemplary embodiments is not set to three. Depending on the desired cooling action and distance, it is also possible to provide fewer or more fins. In particular if several arrays of the first exemplary embodiment are stacked, it may be expedient to use thinner heat sinks having, for example, only two fins, because the heat sinks 4 comprising three fins 8 as shown result in a comparatively large distance between adjacent storage cells 2.

A centering unit for radially centering the cells 2 inside a cell block, or relative to the spacer elements, may be provided. Such a centering unit can be implemented using dowel pins and fitted bores in the spacer elements and conductors, or other measures.

In a further modification, only two, or more than three, tension rods are used on each side.

In a final modification, a tensioning strap is used instead of tension rods for clamping the cell block.

In the exemplary embodiments, a heat sink or a spacer or a plurality of heat sinks disposed between current conductors and intermediate pieces shall be understood as a spacer element within the meaning of the invention.

The properties and explanations of the exemplary embodiments and modifications can, of course, be applied to other exemplary embodiments and modifications, unless this is not apparent or expressly excluded.

### LIST OF REFERENCE SIGNS

2 Storage cell

4, 4*, 4′, 4″ Heat sink

6 Solid part

8 Fin

10 Through-hole

12 Active part of 2

14 Sealing seam of 2

16 Current conductor of 2 ((+) and (−))

18 Pole bore in 14

20 Pressure surface

22 Counter-surface

24 Intermediate piece

26 Enveloping film of 2

28 Pin or tension rod

30 Gap

32 Spacer

34 Free space of 4″

36 Relief bore of 4″

Express reference is made to the fact that the above list of reference signs is an integral part of the description.

1-24. (canceled)

25. An electric energy storage device, comprising: a plurality of flat storage cells (2) for storing and delivering electric energy, having opposing, flat current conductors (16), a plurality of spacer elements (4, 4* 4′, 4″, 32) for maintaining a predetermined distance between the storage cells (2), and
a clamping means (28) for clamping the cells (2) to form a stack, wherein the cells (2) are clamped by the clamping means (28) at the respective current conductors (16) between spacer elements (4, 4*, 4′, 4″, 32) by means of a force fit, wherein at least some of the spacer elements (4, 4*, 4′, 4″, 32) are designed as heat sinks (4, 4*, 4′, 4″), and wherein the heat sinks (4, 4*, 4′, 4″) comprise fins (8) that protrude laterally out of the stack.

26. An electric energy storage device, comprising: a plurality of flat storage cells (2) for storing and delivering electric energy, having opposing, flat current conductors (16), a plurality of spacer elements (4, 4*, 4′, 4″, 32) for maintaining a predetermined distance between the storage cells (2), and
a clamping means (28) for clamping the cells (2) to form a stack, wherein cells (2) are clamped by the clamping means (28) at the respective current conductors (16) between spacer elements (4, 4*, 4′, 4″, 32) by means of a force fit, wherein at least some of the spacer elements (4, 4*, 4′, 4″, 32) are designed as heat sinks (4, 4*, 4′, 4″), and wherein the heat sinks (4, 4*, 4′, 4″) are thermally connected to the current conductors (16) by means of a soft, heat conducting material.

27. An electric energy storage device, comprising: a plurality of flat storage cells (2) for storing and delivering electric energy, having opposing, flat current conductors (16), a plurality of spacer elements (4, 4*, 4′, 4″, 32) for maintaining a predetermined distance between the storage cells (2), and
a clamping means (28) for clamping the cells (2) to form a stack, wherein cells (2) are clamped by the clamping means (28) at the respective current conductors (16) between spacer elements (4, 4*, 4′, 4″, 32) by means of a force fit, wherein at least some of the spacer elements (4, 4*, 4′, 4″, 32) are designed as heat sinks (4, 4*, 4′, 4″), and wherein the spacer elements (4, 4*, 4′, 4″, 32) comprise relief bores (36) for weight reduction purposes.

28. An electric energy storage device, comprising: a plurality of flat storage cells (2) for storing and delivering electric energy, having opposing, flat current conductors (16), a plurality of spacer elements (4, 4*, 4′, 4″, 32) for maintaining a predetermined distance between the storage cells (2), and
a clamping means (28) for clamping the cells (2) to form a stack, wherein the cells (2) are clamped by the clamping means (28) at the respective current conductors (16) between spacer elements (4, 4*, 4′, 4″, 32) by means of a force fit, wherein at least some of the spacer elements (4, 4*, 4′, 4″, 32) are designed as heat sinks (4, 4*, 4′, 4″), and wherein two heat sinks (4, 4*, 4′, 4″) are disposed between adjacent current conductors (16).

29. The electric energy storage device according to claim 28, wherein an intermediate piece (24) is disposed between the two heat sinks (4, 4*, 4′, 4″).

30. An electric energy storage device according to claim 29, wherein the heat sinks (4, 4*, 4′, 4″) comprise fins (8).

31. The electric energy storage device according to claim 30, wherein the fins (8) on the heat sink (4, 4*, 4′, 4″) are offset non-symmetrically away from the current conductor (16) in the stacking direction.

32. An electric energy storage device according to claim 31, wherein the heat sinks (4, 4*, 4′, 4″) comprise pressure surfaces (20), which exert pressure on the current conductors (16) by means of the clamping means (28), and one or more free spaces (34), which are recessed in the stacking direction in relation to the pressure surfaces (20).

33. An electric energy storage device according to claim 32, wherein the clamping means (28) comprises a plurality of, preferably four or six, tension rods, which extend through bores in the current conductors (16) and spacer elements (4, 4*, 4′, 4″, 32) and are preferably surrounded by an electrically insulating material or enclosed by a continuous insulating sleeve.

34. An electric energy storage device according to claim 33, wherein some of the spacer elements (4, 4*, 4′, 4″, 32) are equipped for electric through-plating in the stacking direction and other spacer elements (4, 4*, 4′, 4″, 32) are equipped for electric insulation in the stacking direction and the spacer elements equipped for electric through-plating are preferbly produced from an electrically conductive material.

35. The electric energy storage device according to claim 34, wherein the spacer elements equipped for electric through-plating comprise contacting elements that are produced from an electrically conductive material and received in the respective spacer element.

36. The electric energy storage device according to claim 35, wherein the contacting elements are sleeves through which tension rods of the clamping means extend.

37. An electric energy storage device according to claim 36, wherein the spacer elements equipped for electric insulation are produced from an electrically insulating material, preferably a glass or ceramic material.

38. An electric energy storage device according to claim 37, wherein the heat sinks (4, 4*, 4′, 4″) are produced from an easily heat conducting material, such as a metal, a ceramic material, or a composite material.

39. An electric energy storage device according to claim 38, wherein the heat sinks (4, 4*, 4′, 4″) are equipped for through-plating and are produced in particular from a conductive material, such as a conductive ceramic material, a conductive composite material, a metallic conductor material, or the like.
